(19) United States
(12) Patent Application Publication
(10) Pub. No.: US 2007/0168287 A1
(43) Pub. Date: Jul. 19, 2007

(54) Method and apparatus for distributing media in a pay per play architecture with remote playback

(75) Inventors: Tom McCarthy, Nashua, NH (US); Jateen Parekh, San Francisco, CA (US); Mark Goodwin, Mountain View, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Digital Networks North America, Inc., Santa Clara, CA (US)

(21) Appl. No.: 10/622,146

(22) Filed: Jul. 16, 2003

(51) Int. Cl. G06Q 99/00

(52) U.S. Cl. 705/51

(57) ABSTRACT

A system for rendering media content in accordance with the invention includes a first platform for storing media content, wherein the media content comprises an unrenderable state when received by the first platform. The system further includes a second platform that is communicatively coupled with the first platform for rendering the stored media content. The first and second platforms cooperatively provide an interface for purchasing a right to render the stored, protected media content at least one time. In the system, at least one of the first and second platforms is operable to convert the stored media content to a renderable state upon the purchase of the right to render.

### FIELD OF INVENTION

The current invention relates to entertainment devices and, more specifically, to systems and methods for playing back media content on a pay-per-play basis.

### BACKGROUND

Advances in technology have led to numerous changes in the availability of entertainment content (e.g., audio and video content) to consumers. Such advances include the proliferation of cable television, digital satellite service television, high-definition television and satellite radio, among numerous other delivery mechanisms for audio and video content, such as music, movies, and the like. Another recent advance in this area is the delivery of media content over high-bandwidth connections to the Internet. Such high-bandwidth connections comprise data-over-cable (cable modems), digital subscriber lines and satellite systems. Further, private entertainment systems may also provide access to audio and video content, such as to guests in a hotel, for example.

These technological advances now offer content owners such as movie producers, television program producers, music producers and other originators of audio/video content with a variety of options for distributing their work. Movie producers and television programming producers, for example, may now work with service providers to package their content and distribute it via cable, satellite, or the Internet. Movie producers may enjoy their first-runs in theaters, for example, and be able to count on continued revenues from royalties earned by having their movies run on cable.

Service providers, such as television broadcasters, cable providers, digital satellite providers, along with content owners that access consumers through established broadcast systems (such as, for example Home Box Office), may generate revenue by providing content on a pay-per-view or pay-per-play basis (collectively pay-per-view or PPV). When providing content on a PPV basis, a consumer pays the content owner and/or broadcast service provider (e.g., cable television company) for the right to view or play certain content on a per view/play basis. As one example, a hotel guest may purchase the right to view a first run movie in his/her hotel room through an in-room entertainment system. The guest is then billed on his/her hotel bill for the purchased viewing of the movie. Similar scenarios exist for numerous cable television and digital satellite service subscribers. These subscribers have the option to viewing rights for movies, live sporting events, among other content, on a pay-per-view basis and are billed accordingly.

Despite the wide variety of distribution outlets available to content owners, only a very limited amount of their work is actually accessible by consumers at any specific time. A vast amount of their work remains on the shelf, despite the fact that there may indeed be an audience for it. The inaccessibility of the media results in large part from the fact that content owners must share limited time-slots on limited channels in the service providers' programming schedules. Content owners have no more flexibility on PPV systems. While some flexibility in the start time of such PPV content may be possible, consumers are limited to viewing current offerings that are available on a limited channel set (in the case of cable television systems.)

Such arrangements are disadvantageous to consumers. One problem is that the selection of media content available to consumers is limited. Consumers simply do not choose the content to be programmed. The providers do. It is similarly disadvantageous to content owners because revenue is only generated on content currently being offered for viewing/playing by the service provider.

Current pay-per view systems also fail to provide viewers with much viewing flexibility for a specific programming selection. In this respect, PPV-delivered media content is similar to broadcast content in that a consumer must consume the content from beginning to end when purchased without the ability to pause and resume viewing, as they desire.

Based on the foregoing, an approach for providing PPV content that better utilizes available content and provides consumers with more selection and increased viewing flexibility is desirable.

### SUMMARY

In accordance with an exemplary embodiment, a system for rendering media content comprising a first platform and a second platform. The first platform may store media content, wherein the media content comprises an unrenderable state when received by the first platform. The second platform, communicatively coupled with the first platform, renders the stored media content. The first and second platforms cooperatively provide an interface for purchasing a right to render the stored media content at least one time. At least one of the first platform and the second platform may convert the stored media content to a renderable state upon the purchase of the right to render.

In one respect, the first platform may be a media server comprising a dedicated media storage and serving device for retaining a plurality of units of media content. The media server may comprise a client platform manager that contains one or more parameters corresponding with functional attributes of at least one client platform. A media communication interface communicatively couples the media server to at least one media content source and to the client platform. The media server also comprises a media content manager that provides for the purchase of the right to render the media content.

In another respect, the second platform may be a media client comprising a media rendering device interface operable to couple renderable media to a media rendering device. A local discovery service communicates with a media server to determine the availability of media content that may be purchased by a user and made renderable upon completion of a purchase transaction. A media communication interface communicates with the media server and a decoder converts the media content from an encoded format to a format that corresponds with the media rendering device.

In another respect, a method is provided for rendering media content on a pay-per-play basis. The method may provide for receiving media content with a first device, wherein the media content comprises at least one level of content unrenderability and for storing the media content locally. The method may provide for displaying a content guide comprising a listing describing the unrenderable media content. The user may make a request to purchase a rendering right for the protected media content, the request being generated using the content guide. The method may also provide for removing a first level of content unrenderability. The media content may then be rendered at least one time, wherein at least a part of the media content is rendered on a second device.

These as well as other aspects and advantages will become apparent to those of ordinary skill in the art by reading the following detailed description, with reference where appropriate to the accompanying drawings. One of ordinary skill in the art will appreciate that this summary is intended to provide a brief overview of some of the embodiments of the present system, and it is not intended to be an exhaustive or exclusive. The scope of the invention is to be determined by the attached claims and their equivalents.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanying drawings in which:

FIG. 1 is a block diagram illustrating a pay-per-view system in accordance with an exemplary embodiment of the invention;

FIG. 2 is a block diagram illustrating a pay-per-view system in accordance with another embodiment of the invention;

FIG. 3 is a block diagram illustrating a first platform for use in the pay-per-view system of FIG. 1;

FIG. 4 is a block diagram illustrating a second platform for use in the pay-per-view system of FIG. 1;

FIG. 5 is a flowchart illustrating a method for distributing pay-per-view content in accordance with an embodiment of the invention; and

FIG. 6 is a block diagram illustrating a pay-per-view system in accordance with yet another embodiment of the invention.

### DETAILED DESCRIPTION

In the following detailed description, numerous specific details are set forth in order to provide a thorough understanding of the invention. However, it will be understood that the present invention may be practiced without these specific details. In other instances, well-known methods, procedures, components and circuits have not been described in detail, so as not to obscure the present invention.

Furthermore, additional implementation details for features described below may be found in the following pending patent applications and issued patents, all of which are incorporated herein by reference:
“Video Data Recorder With Integrated Channel Guide,” U.S. Pat. No. 6,324,338, Filed Nov. 27, 2001;
“Method and Apparatus For Fast Forwarding and Rewinding in a Video Playback Device,” U.S. Pat. No. 6,360,053, Filed Mar. 19, 2002;
“Pay Per View Architecture Providing For Local Storage of Content,” U.S. patent application Ser. No. 09/412,992, Filed Oct. 5, 1999;
“Apparatus For Viewing Television with Pause Capability,” U.S. patent Ser. No. 10/396,229, Filed Mar. 24, 2003;
“Network Video Unit, U.S. patent application Ser. No. 10/215,904, Filed Aug. 9, 2002.
   1. Overview

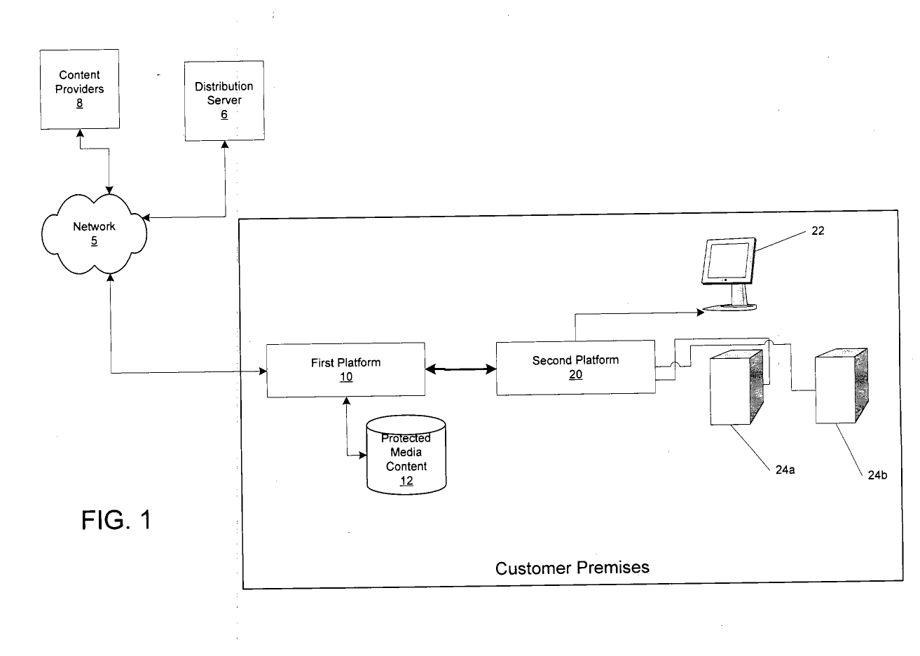

FIG. 1 depicts operation of an exemplary embodiment of a system for rendering media content comprising a first platform 10 and a second platform 20 cooperatively operating within a customer premises. The first platform 10 receives and then stores media content in an unrenderable state where appropriate. The unrenderable media content comprises content having digital rights associated with it, and is therefore unrenderable in that it is disabled from viewing until purchased by the viewer. The first and second platforms cooperatively provide an interface for purchasing a right to render the stored, unrenderable media content. For example, a user may purchase protected media content stored at the first platform 10 via a user interface at the second platform 20. The user interface may present the viewer with a list of media that is available for purchase, along with the status of media that has been purchased already.

The second platform 20 is communicatively coupled with the first platform 10 to facilitate rendering of the stored media content. The unrenderable media content becomes renderable, upon purchase by the user. Preferably, the process of making media content renderable upon purchase by the user involves decryption, or any other suitable scheme. For example, the media content may be password protected, or made unrenderable by another scheme performed by the media content provider. A preferred scheme for making media content renderable would involve collaboration with the content providers to ensure that the media content may be made viewable by the user that purchases the rights to it, but remains protected from unauthorized copying at all times.

In an exemplary embodiment, the system of FIG. 1 advantageously permits a user to have content “pushed” to the system for later viewing. The system may be used as a pay-per-view and/or play platform to permit users to purchase and then view content that has been downloaded for purchase. The system may also be used as a Personal Video Recorder (PVR) to permit users to view content that does not require purchase. When the user selects content to view and it is in an unrenderable state, at least one of the first platform and the second platform may be used to convert the stored media content to a renderable state in response to the purchase of the right to render such content.

The system in FIG. 1 advantageously allows a user to configure a completely personalized entertainment system. The user may receive content from a plurality of content providers 8 connected to the user's system via a network 5. The content providers 5 may provide protected audio, audio/visual, or any other type of media for download over the network 5. A distribution server 6 may monitor downloads as an intermediary between the content providers 5 and the system. The distribution server 6 may receive requests for content, requests to search for content and information about the user. Responsive to the requests, the distribution server 6 may retrieve content from the content providers 5 and make it available to the user. The user may, however, search for and retrieve content independently of any distribution server 6.

In exemplary embodiments, the distribution server 6 may communicate with either the first, second or both platforms 10, 20 in the system to authenticate and track the usage, payment, and commerce of the content. The distribution server 6 also may interface with a service provider's accounting system to obtain and use information about the users of the system.

The system in FIG. 1 may take a wide variety of forms many of which are described in further detail below. One of ordinary skill in the art will appreciate that the following describes examples of alternative embodiments and that other examples may fall within the scope of the appended claims.

In addition, the following description makes reference to a system that provides pay-per-view (PPV) of audio/visual content such as movies. Embodiments of the system below, however, also provide pay-per-play options for users who wish to purchase music from networked content providers and pay to listen to audio content for a limited time. One of ordinary skill in the art will appreciate that the terms “pay-per-play” or “PPPlay” shall be understood to encompass systems that permit the purchase of both audio-visual content and audio content, or any other content that users may desire to obtain with such a system. Such content would include without limitation movies, television programs, live or not-live telecasts of events such as sporting events, music performances, music recordings, or other multi-media or single media content such as games.

In addition, one of ordinary skill in the art will appreciate that the term “pay-per-play” or “PPPlay” is not limited to any particular type of transaction. For example, PPPlay encompasses a transaction in which a user may download media content and pay for its viewing, whether once or another fixed number of viewings. PPPlay also encompasses transactions based on a subscription service. For example, a user may subscribe to a service that provides media to the user for viewing during a period of time. The media may be downloaded to the first platform 10 in an unrenderable state. The user's subscription may provide the mechanism in the system to purchase the media and thereby make the media renderable. The media may be maintained in its renderable state for a limited period of time after which it becomes unrenderable. Other examples of subscription services may also be implemented.

2. An Exemplary Embodiment of a System for Rendering Media Content

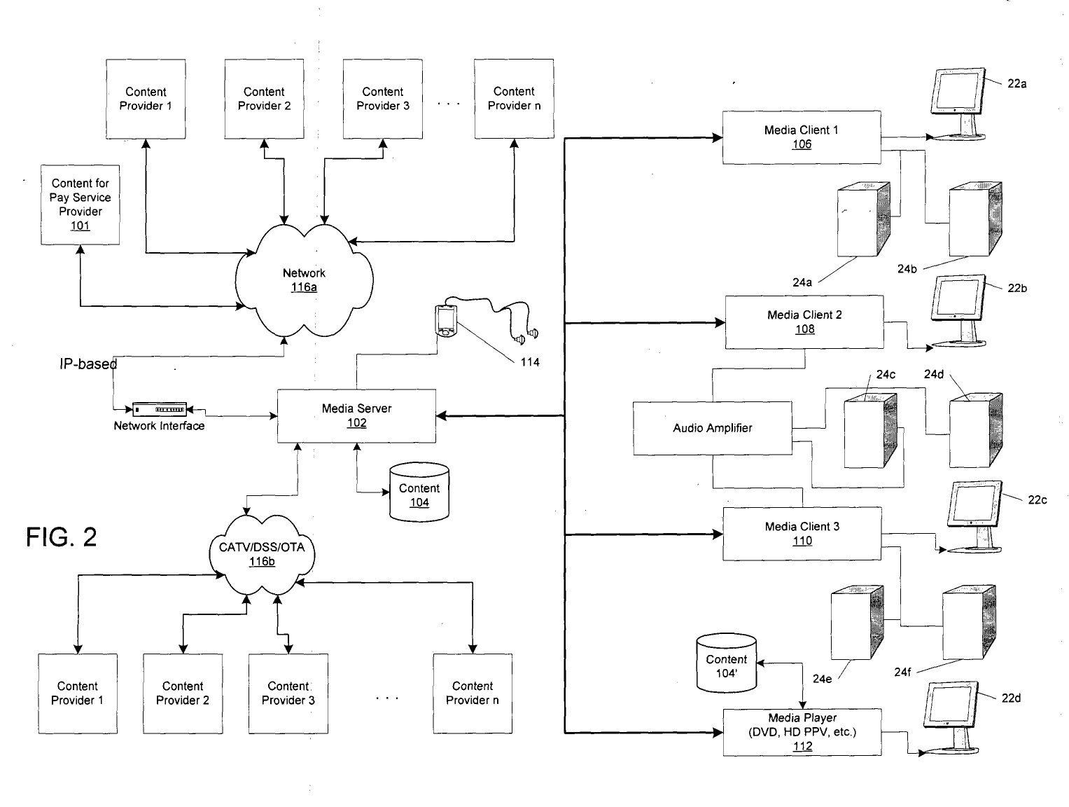

FIG. 2 depicts operation of another system for rendering media content in accordance with an embodiment of the invention. The system of FIG. 2 comprises a first platform in the form of a media server 102, which stores media content that may be rendered by the system. The media server 102 receives media content in either a renderable or an unrenderable state and stores that content on a content storage device 104 coupled to the media server 102. The storage device 104 is shown in FIG. 2 as a separate component. However, it will be appreciated, the storage device 104 may be included in the media server 102.

Whether media content is in a renderable or unrenderable state is dependent upon the extent to which the content provider requires digital rights management for the content. The media server 102 may receive content that is broadcast by a broadcast network or by a content distributor (e.g. CATV distributors such as HBO®) and intended for instant viewing upon receipt. Such content may be free as being broadcast over the air by public broadcasters, or it may be part of content that comes with purchased access. For example, a user may subscribe to HBO® as part of a cable package and media content received via an HBO® channel would be received by the media server 102 in a renderable state.

The media server 102 may also receive content in an unrenderable state that would require the user to purchase in order to become renderable. Such content may be purchased as pay-per-view (or pay-per-play), or as part of a subscription service. In a pay-per-view/pay-per-play scenario, the user may receive media content through a discovery process initiated by a discovery service in the first or second platforms or by a service distributor (e.g. the content for pay service provider 101 described below) accessible via a data network 116a. The discovery process may be completely automated using a set of user preferences set or configured by specific users of the service, or it may be performed using manual content searches. The discovery process searches and receives media content in an unrenderable state to be made renderable upon purchase by the user. The process for converting the media content to an unrenderable state and then to a renderable state would preferably require a collaboration between the content for pay service provider and the content provider.

In a subscription service, a user may order media content for a period of time and the media content may be available for rendering only in that period of time. In a subscription scenario, media content may be stored on the media server 102 in either a renderable or an unrenderable state. Preferably, the media server 102 would receive the content in an unrenderable state, but provide the user with the option with purchasing it to make it renderable and continue to store the media content in a renderable state for the allotted time period. Upon expiration of the time period, the media content would then become unrenderable.

The media content may be stored in the system of FIG. 2 by employing the storage device 104 and, further, the media content may be stored in a compressed format. In this regard, the media content may be stored in a format that is in accordance with one of the MPEG-1, the MPEG-2 and the MPEG-4 standards. As another alternative, the media content may comprise audio content that exists in a compressed format in accordance with layer 3 of the MPEG-1 standard. The media content may also be stored as encrypted versions of files that have been compressed in accordance with MPEG-based standards, or any other suitable standard.

Examples of suitable compression technologies that may be implemented for video include without limitation:
MPEG-1
MPEG-2
MPEG-4
MJPEG
Wavelet based compression technologies
H.264
H.261
H.263
DV
MOV
AVI
Windows Media
Quicktime
RealMedia
Encoding and Compression based on 3D algorithms and object based algorithms (VP6 from On2, for example)
   Examples of suitable compression technologies that may be implemented for audio signals include without limitation:
MPEG-1 layer 2 (Musicam)
MPEG-1 layer 3 (MP3)
OGG (Ogg Vorbis)
WAVE
WMA
PCM
ITU G.711
RealAudio

The system of FIG. 2 also comprises a plurality of media clients 106, 108 and 110 that are communicatively coupled with the first platform for rendering the stored media content. The media clients may take any number of forms, as will be discussed in further detail below. The system of FIG. 2 further comprises a media player 112 that is also communicatively coupled with the media server 100. The media player 112 may take the form of a multiple format DVD player, a digital video recorder, or a networked video unit, among numerous other devices. Of course, the invention is not limited to the use of any particular device. The system of FIG. 2 also comprises a portable music player 114, which is coupled with the media server 102. The portable music player 114 may comprise a player that renders MPEG-1 layer 3 audio files, for example.

The media server 102 shown in FIG. 2 cooperatively (along with the media clients 106-110 and/or the media players 112 and 114) provides the user with an interface for purchasing a right to render the stored media content at least one time. Further, alternative embodiments for converting the stored unrenderable media to renderable media may be used. The media server 102, the media clients 106-110 and the media players 112 and 114 may all be made operable, alone or in combination, to convert the stored media content to a renderable state upon the purchase of the right to render that content.

As illustrated in FIG. 2, the media server 102 stores content for which a user may purchase the right to render. That content, which is preferably in an unrenderable state, and is stored, for example, on the content storage device 104. The storage device 104 may comprise a hard drive that is included in a digital video recorder, a personal computer, or a file server, as some examples. In these scenarios, the digital video recorder or the personal computer may function as the media server 102. For the scenario where the storage device 104 is included in a file server, the media server 102 may take the form of a client computer coupled with that file server.

In an alternative embodiment, the storage device 104 may comprise an optical storage device, such as a digital versatile disk (DVD) drive. Such a DVD drive may be included in a personal computer, or as a peripheral device in a digital video recorder, as some examples. The DVD drive may be a read only drive or may be a DVD read-write (R/W) drive. For read only drives, the protected media content may be included on a DVD that is placed into the DVD drive by a user. Such a disk may be delivered to the user as part of a subscription service through conventional mail service or via a package courier, for example. For R/W drives, the protected media content may be delivered to the system using, for example, the techniques described below, and written to a DVD using the R/W DVD drive. As shown in FIG. 2, the system includes a plurality of content providers 1 through “n” and 1ₐ through nₐ. Content providers 1 through n are coupled with a first distribution network 116a. For this embodiment, the first distribution network 116a may comprise a packet-based network such as, without limitation, an Internet Protocol (IP) network that may be coupled with the Internet, as an example.

The content providers 1ₐ through nₐ are coupled with a second content distribution network 116b. The second content distribution network 116b may comprise a broadcast network, such as a cable television (CATV) system, a digital satellite system (DSS), or an over-the-air (OTA) system, such as a traditional broadcast television system (NTSC), a high-definition broadcast television system (ATSC), or radio (terrestrial analog, terrestrial digital, and satellite digital). In this regard, it is to be understood that media content herein refers to any audio, audio-visual, or visual media. Such content may come in the form of music, vocal works such as speeches, or any audio work, as well as movies, television programs, videos, video games, or moving pictures of any kind, or as photographs, photo albums, slideshows, or any other pictures as single images or collections of single images.

Users have their access to the content providers managed by a content for pay service provider 101 that is accessible preferably over the data network 116a. The content for pay service provider 101 may be a distribution server as described above with reference to FIG. 1. The content for pay service provider 101 may provide users with a central location for configuring discovery options, managing accounts, obtain billing support, etc. The content for pay service provider 101 may maintain an interface to the content providers used to obtain service. When the user's system performs discovery of content, the PPPlay service provider 101 may operate as an intermediary by connecting to appropriate content providers.

Additionally, as was indicated above, PPPlay media content for the system of FIG. 2 may be provided via physical media that is introduced into the system using, for example, a DVD drive. Based on the foregoing, it will be appreciated that various methods for delivering content on a pay-per-view basis exist and that the invention is not limited in scope to the use of any particular technique. It is noted that the foregoing approaches are exemplary, and any number of content provider configurations may be used. For example, a single content provider may be used to provide media content to such a media rendering system.

The media content may reside on the content storage device 104 in an unrenderable state. The unrenderable state may be implemented using a variety of techniques that exist for protecting such media content from unauthorized use. For example, various file-locking techniques may be used, such as password protection, or other such techniques. Further, encryption and/or the use of digital signatures may be used to protect such content. In an exemplary embodiment, the protected state implementation may evolve by agreement between a service provider and the content provider. The system of FIG. 2 may be required to support different implementations for an unrenderable state.

In the system of FIG. 2, multiple levels of protection may be used at different places in the system to protect the media content from unauthorized viewing and/or playback. In this respect, for certain embodiments, the media content stored in the system of FIG. 2 may comprise a first level of encryption that protects the media content from unauthorized rendering. Depending on the particular situation, this encryption may be implemented by one of the content providers or by an operator of the content distribution network (e.g., the network 116a or the network 116b). Further, the media content may comprise a second level of encryption that protects the media content from unauthorized reception and storage. The second level of encryption may comprise a form of encryption that is implemented by a CATV provider or a DSS provider to protect content they broadcast from being received and used by unauthorized devices.

In exemplary embodiments, the unrenderable state may involve implementing an encryption algorithm based on encryption technologies such as AES, DES, 3DES, as well as any suitable private or public key cryptosystem.

The media server 102 may comprise a dedicated media storage and serving device, such as a specially designed platform for receiving, storing and managing media content. Alternatively, the media server 102 may comprise a first device that stores media content (such as the content storage device 104) and a second device that manages the media content (such as a personal computer coupled with the first device). In such alternative configurations, the first device may comprise a digital video recorder, for example.

The system also comprises one or more rendering/display devices. For example the system 100 comprises plural video display devices and audio speakers 24a-f. The video display devices 22a-d, depending on the particular embodiment, may comprise a video processing unit, a standard television display, a high-definition television display, a flat panel display, among numerous other possibilities. The speakers 24a-f may comprise passive or active speakers (which may depend on the particular type of media client). As another example of a media-rendering device, the media client 108 comprises a digital audio receiver 138. The media client 108 is also coupled with an audio amplifier 140, which may be used to render digital audio (media content) using the speakers 24a-f coupled with the audio amplifier 140 after the digital audio content is decoded by the digital audio receiver 138. Other media rendering systems may include headphones, portable LCD video and audio players.

3. First Platform

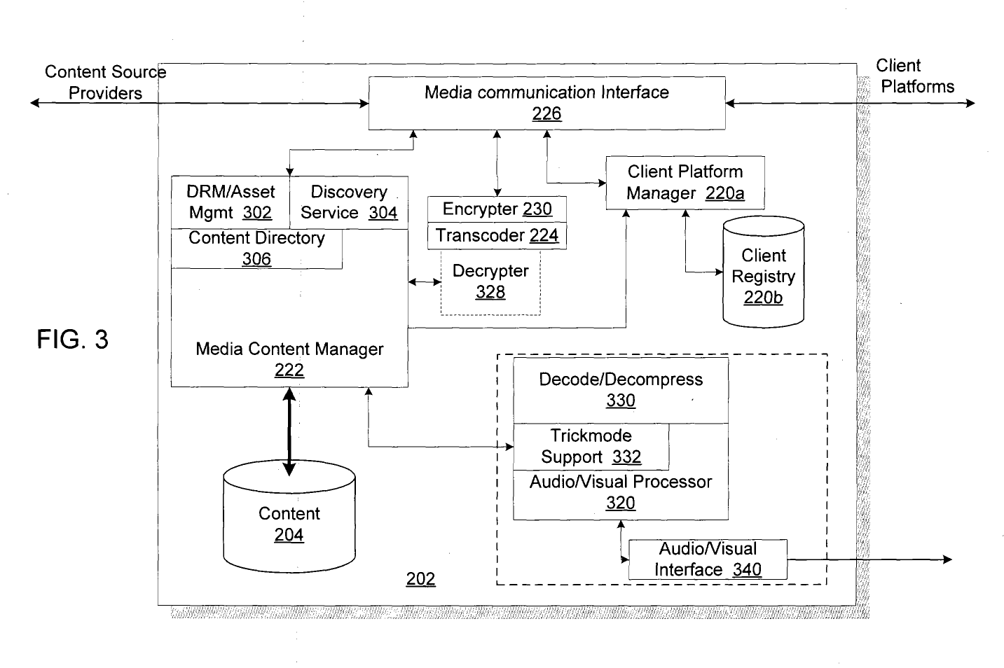

The media server 102 has been described above with reference to FIG. 2 as one example of the first platform shown in FIG. 1. FIG. 3 is a more detailed depiction of a media server 202 in accordance with an exemplary embodiment. The media server 102 shown in FIG. 3 comprises a client platform manager 220a, a client registry 220, a media content manager 222, a transcoder 224, a media communication interface 226, a decrypter 328, and an encryptor 230.

The media server 202 includes a media communication interface 226 to provide communications capabilities with content source providers and with the media clients 106, 108, 110, 112. With respect to communications with content source providers, the media communication interface 226 implements an IP-based interface using cable, DSL, or other suitable connection to communicate with data network connected providers. The media communication interface 226 may also implement suitable hardware and software to communicate with CATV, DSS and/or broadcast television providers.

To communicate with the media clients 106, 108, 110, 112, the media communication interface 226 may comprise a router or hub to connect to a local network (such as a home IP-network) that is used, in part, to communicate media content from the media content storage device 104 (or the media server 102) to at least one of the media clients/players. The media communication interface 226 may also be employed as an in-home data network for communicating between various electronic devices in the house, such as for providing access to the Internet, for example. The media communication interface 226 may be wired or wireless and may communicate on a broadcast, peer-to-peer, or access point scheme. In an exemplary embodiment, the media communication interface 226 comprises a wireless Ethernet access point using for example, a standard IEEE 802.11 wireless network. One of ordinary skill in the art will appreciate that the specific chosen media communication interface 226 is not critical and that any suitable media communication interface 226 may be used.

The media server 202 in FIG. 3 includes software and/or firmware for managing the operation of the system 100. In this regard, the media server 202 implements a client platform manager 220a to manage media clients on the network. The media server 202 also comprises a client registry 220b that contains a listing of the media clients 106-110, the media player 112 and the portable music player 114, along with one or more parameters corresponding with functional attributes of each of these platforms. The client registry 220b is employed by the media server 102 (and the system 100) to determine what types of media content each of the clients/players is capable of rendering, so as to only provide compatible media to these clients/players for viewing/playback. The client platform manager 220a preferably implements an automated client discovery function that connects to the network and detects when the user has added another media client. The client platform manager 220a may then poll the new media client for information to add to the client registry 220b. In a preferred embodiment, the media server 102 and the media clients 106-114 use the SSDP/uPnP (Simple Service Discovery/Universal Plug n' Play) to discover other media clients. The media server 202 also comprises software, hardware and/or firmware that implements a media content manager 222. The media content manager 222 includes a discovery service 304, which accesses media content by communicating with content providers over the chosen network. Content may be discovered by the discovery service 304 using a variety of techniques. For example, the discovery service 304 may implement a search for user-provided titles, or for content based on search criteria, such as movies starring particular actors/actresses. The discovery service 304 may also implement a user profile-based search for content. User profiles may be developed over time according to types of specific content that is requested over time, or they may be built from responses to user prompts.

The media content manager 222 also includes a digital rights management and asset management function 302 to manage monitoring and purchasing rights to render the stored media content as well as enforcement of digital rights associated with the media content. Such digital rights may include copyright protections, number of playback cycles that a user may perform, among any number of other digital rights associated with the purchased right to render the media content. These digital rights may be included in a data file along with the media content, such as in an attributes portion of the data file. In this respect, meta-data (or meta-tags) may be employed to provide the digital rights associated with the media content along with the media content itself.

The digital rights management and asset management function 302 additionally includes logic for controlling the rendering of media content in correspondence with the terms of the purchase of the right to render the media content (including the digital rights). Such terms may include the number of times a specific item (e.g. movie, music selection, etc.) may be rendered, what type of device may be used to render the content (e.g., no portable players, only high-definition displays, etc.) and whether rendering is limited to a single device or if multiple devices may be used, as some examples. It will be appreciated that any number of techniques for controlling the rendering of media content and enforcing digital rights associated with that content are possible. The specific techniques employed depend, at least in part, on the particular embodiment. The invention is, of course, not limited to the use of any particular techniques for implementing such software, hardware and/or firmware.

The media content manager 222 also includes a content directory function 306 operable to generate a user interface on either the media server 202 or on one of the clients 106, 108, 110 and 112. The content directory function 306 preferably communicates with the discovery service 304 and the asset management function 302 to determine and report the status of each piece of media content available for purchase or for viewing. The content directory function 306 may also communicate with content directory functions on the media clients 106, 108, 110, 112 to display narrower directory content focusing on the interests of specific individuals that share the use of the system 100 in the customer premises.

The media server 202 also includes a transcoder/transrater (transcoder) 224. The transcoder 224 is employed to translate media content from a first format to a second format. In this regard, media may be received in a first format, such as MPEG-2 format. The media server 202 may then transcode the media content to a different format, such as MPEG-4, for example. This transcoding may be performed due to the functional capabilities of a media client, as defined by one of the client registry 220 attributes of the client/player to which the media server 202 communicates the media content. For example, the media client 106 may comprise a low-bit rate media-rendering device that is not capable of rendering an audio/video stream in MPEG-2 format. Therefore, in this particular situation, the media server 202 may transcode the media content (using the transcoder 224) to MPEG-4 format to provide a lower bit rate media stream to the media client 106. As an alternative, a transrater may be employed to modify the bit-rate of the media content without modifying the encoding technique implemented.

Transcoding/transrating may also be used to reduce the amount of bandwidth used on a media communication interface 226 included in the media server 202 when communicating with the media clients/players over a network. Transrating may reduce the bit rate of media content communicated over the network 126 and may thereby improve the efficiency of the network.

The media server 202 may also optionally comprise a decryptor 328. The decryptor 328 may comprise hardware, software and/or firmware to decrypt multiple levels of encryption used to protect the media content. In this regard, the decryptor 328 may decrypt a first level of encryption applied to the media content to protect the media content from unauthorized reception and/ or storage when such content is received from a content distributor, such as via the network 116a or the network 116b (See FIG. 2). Such decryption may be related to a transmission protocol implemented by a content distributor.

Further, the decryptor 328 may decrypt a second level of encryption applied to the media content. This second decryption operation may be related to the prevention of unauthorized viewing/playback of the media content. Thus, the second decryption is typically performed in response to the purchase of a right to render the media content, as has been previously described. This is a desirable approach as the media content remains in an encrypted state until the right to render that content has been purchased. Once the second level of encryption is removed, the media content may be said to be in a renderable format (or is renderable content). The renderable content may then be rendered using the media server 202 by employing a rendering device (not shown) coupled with the media server 202. Alternatively, the media content may be communicated to one of the media clients (106-110) or one of the media players (112 and 114) coupled with the media server 202. As was mentioned above, the media content may be transcoded or transrated prior to being communicated from the media server 202 to one of the media clients/players.

In addition to being transcoded or transrated, the renderable media content may also be encrypted again (using an encryptor 130 included in the media server 202) prior to communication of the renderable content to one of the media clients/players. The encryptor 230 may apply, for example, public/private key encryption to a media stream signal. In this respect, the encryptor 230 may apply encryption to the media stream signal using a public key corresponding with the media client 108. The encrypted media stream signal may then be communicated to the media client 108 and decrypted using a decryptor 232 with a private key of the media client 108. Such a configuration protects the media content from transmission to an “untrusted” client/player device, which, in turn, prevents unauthorized use of the media content. When the media stream is decrypted, it is then be decoded by employing the decoder 330 and rendered using a rendering device, as described in more detail below.

In exemplary embodiments, the media server 202 may optionally provide direct rendering capabilities and may further include an audio/visual interface 340. The audio/visual processor 320 may further include a decoder/decompressor 330, and a trickmode support function 332. The decoder/decompressor 330 may be implemented to convert the content format to a format suitable for display. The trickmode support function 332 may be used to allow the user to reverse, pause, fast forward, stop, etc. the content being displayed according to the user's convenience. In this way, the trickmode support function 332 may interface with a remote control device or with a front panel interface.

One of ordinary skill in the art will appreciate that FIG. 3 depicts one example of the media server 202 and that others may be possible.

4. Second Platform

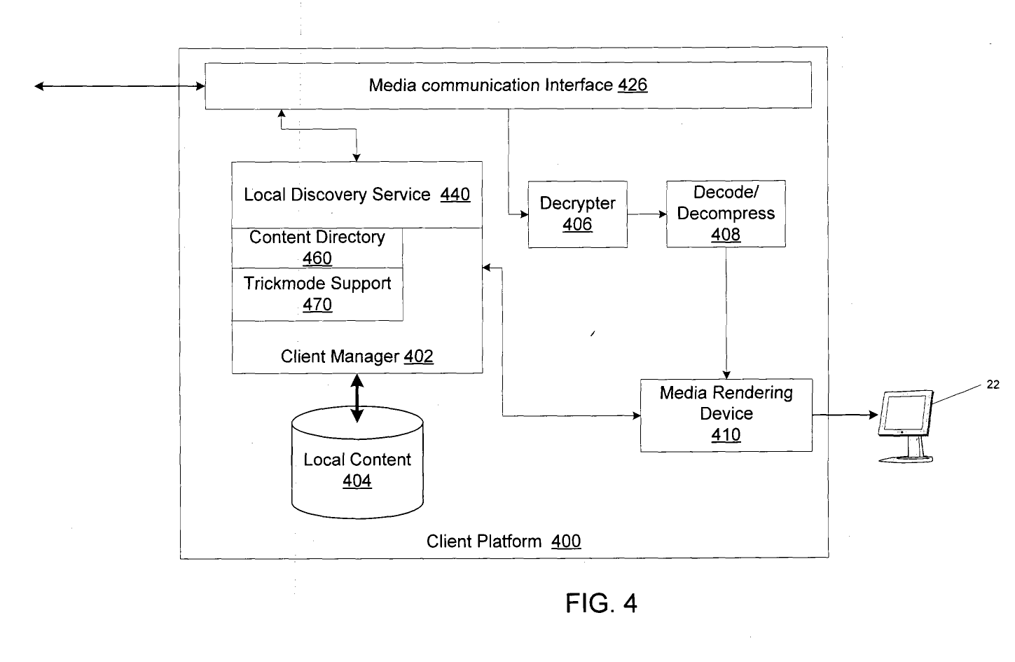

Referring back to FIG. 1, the media client 106 provide a user with the ability to access the media content stored on the media server 102. FIG. 4 is a more detailed depiction of a media client 400 in accordance with an exemplary embodiment.

In the system shown in FIGS. 1 and 2, the media clients 20 and 106 are primarily responsible for rendering content and in some embodiments, for providing an interface to purchase content stored in the media server 102. The media client 400 in FIG. 4 depicts additional functionality that may be performed by the media clients. The media client 400 in FIG. 4 comprises a client manager 402, a local content storage device 404, a decrypter 406, a decoder 408, and a media rendering device 410. The media client 400 may also include a media communication interface 426 to communicate with the media server 102.

The client manager 402 comprises a local discovery support service 440, a directory content function 460, and a trickmode support function 470. The local discovery service 440 may comprise software, hardware and/or firmware. The media discovery service 440 communicates with the media server 102 via a network interface 426 and the local network to “discover” the composition of the media content stored on the media server 102 (or on the content storage device 104). In this respect, the media client 400 (e.g., using the discovery service) communicates with the media service to determine what portions of the media content are available for rendering using the media client 400 (e.g., what portions of the media content the media client 400 is capable of rendering). The discovery service 440 may then operate in conjunction with a directory content function 460 to provide a listing of the portions of the media content stored on the media server 102 (or the content storage device 104) that are available for viewing immediately, or for purchase on a PPPlay basis to become renderable by the media client 400. Such a list may be displayed, for example on the video display device 24 coupled with the media client 400.

The media client 402 may also comprise a trickmode support function 470, which may be included as part of the client manager 402. The trickmode support function 470 provides the user with total viewing control by providing a Pause, Stop, Rewind, Fast Forward, and other viewing control functions.

The media client 400 additionally comprises a decrypter 404 that, in certain embodiments, may decrypt content that has been encrypted by either the content providers or by the media server 102. The decrypter 404 may decrypt the content on a first level pursuant to a purchase by the user, or on further levels for the purpose of protecting the signal from being intercepted and used by unauthorized parties.

The media client 400 additionally comprises a decoder 406 that, in certain embodiments, converts the media content stream communicated from the media server from an encoded format to a format that corresponds with the media rendering device (e.g., video display device 134). Decoding of such a media content stream signal typically occurs after the decryptor 132 has decrypted encryption of the media stream.

The media client 400 also comprises a media rendering device 410 to ensure that content is converted to a format that is suitable for display on the display unit 24.

As was previously indicated, media clients 106-110 may take any number of forms. For example, the media clients may comprise a digital video recorder, a digital audio receiver, a video processing unit that performs high performance decryption, decoding and video/audio processing, among any number of other possible media clients.

5. Exemplary Methods for Rendering Media Content

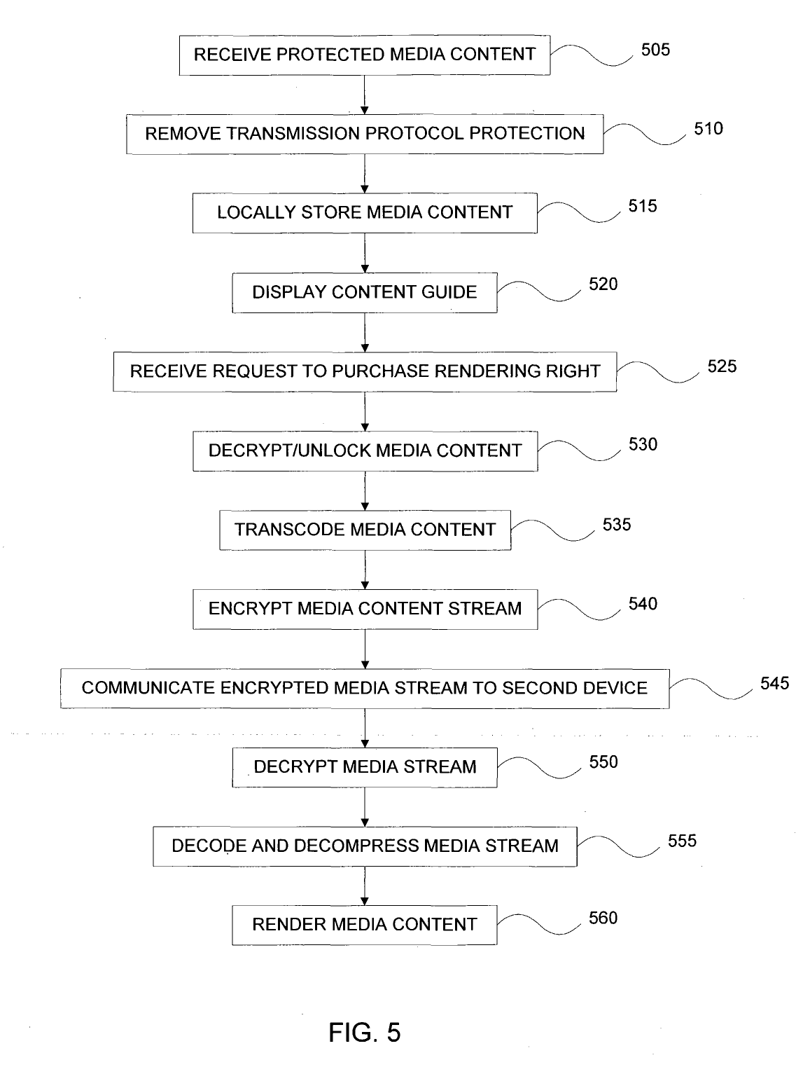

Referring now to FIG. 5, a flowchart illustrating a method 500 for rendering media content in accordance with an embodiment of the invention is shown. The method 500 may be implemented using any of the systems described herein, as well as other embodiments of media rendering systems.

The method 500 comprises, at block 505, receiving unrenderable media content. Such media content may comprise various types and/or levels of protection, which protect that content from unauthorized reception and use, as has been previously described. The media content may be audio content and/or audio/video content, for example. Alternatively, the media content may be photographs, or the like. At block 510, a transmission protocol encryption level is removed from the media content. Such a transmission protection level may be implemented by a content distribution service, such as CATV or DSS providers, to prevent unauthorized reception of the media content, as was indicated above. It is noted that the media content for this particular embodiment includes another level of protection to prevent unauthorized rendering of the media content and will be discussed in further detail below.

At block 515, the media content is locally stored. As previously described, the media content may stored using a hard disk drive or may be stored on, for example, a DVD. It will be appreciated that various techniques for storing the media content (which still comprises an unrenderable state) exist. In this regard, while a number of techniques for storing such media content are described herein, the invention, of course, is not limited to any particular technique or approach.

At block 520, a content guide may be displayed on either a first or second device of a media rendering system in which the method 500 is being implemented. Using this content guide, a user may indicate the desire to purchase a rendering right to view/playback the protected media content (or at least a portion of it), which, in turn, generates a request that may be communicated to and/or received by the first device at block 525. The purchase request may also be communicated to a content provider for billing purposes or, alternatively, to a central accounting server that is maintained by the content distribution service (not shown).

After a rendering right has been purchased, at block 530, the media content is decrypted (such as by using a private key) or is unlocked (such as through password protection, or the like), such that the media content is available to be rendered. The media content may then be decoded, decompressed and rendered by the first device (a process not shown in FIG. 5). Alternatively, as is shown at block 535 in FIG. 5, the media content may be transcoded to account for one or more playback attributes of the second device (e.g., media client) in a system in which the method 500 is being implemented. In this situation, is it is assumed that the second device cannot efficiently render the media content (or render that content at all). Therefore, the media content is converted from one format (e.g., MPEG-2) to another format (e.g., MPEG-4) to accommodate the capabilities of the second device. Alternatively, the media content may be transrated (e.g., sampled to reduce the bit rate) to reserve bandwidth on a local network used to communicate the media content, or to account for the capabilities of the second device, as was previously described.

At block 540, the media content is placed in an encrypted media stream for transmission from the first device (e.g., a media server) to the second device (e.g., a media client). Various encryption techniques are possible and the invention is not limited to any particular approach. However, as one example, a secure-socket-link type encryption may be used. At block 545, the encrypted media stream is communicated to the second device (e.g., over a network, as have been previously described) and decrypted at block 550. The media content is decoded and decompressed at block 555 and rendered at block 560. The approaches for decoding, decompressing and rendering depend, at least, on the type of media content and the particular system in which the method 500 is being implemented. It will, of course, be appreciated that numerous such approaches are possible.

6. Exemplary Embodiment with Internet-based Media Source

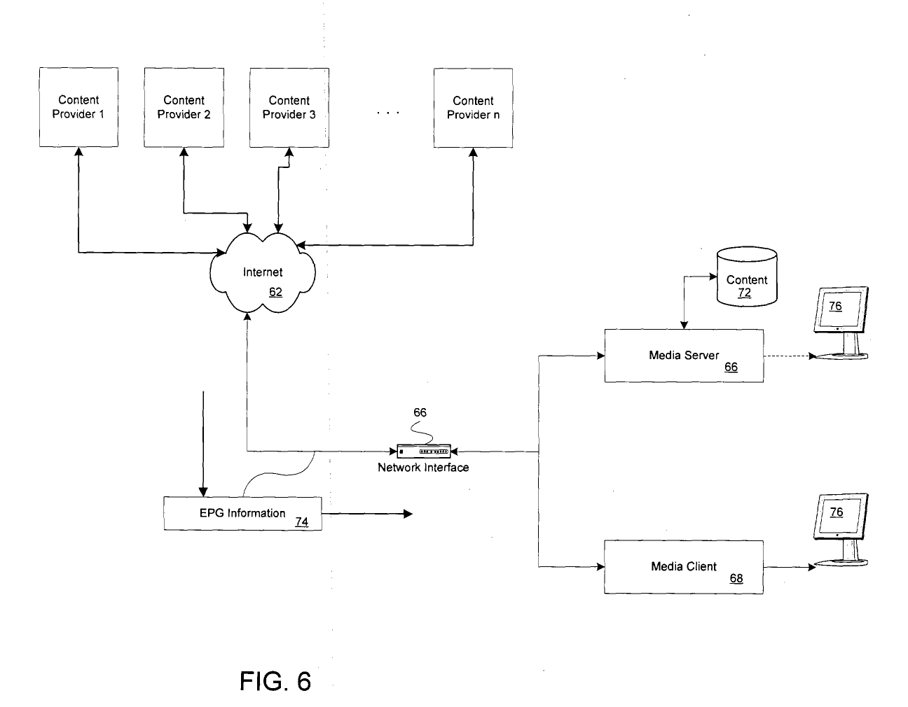

Referring now to FIG. 6, an alternative system 200 for rendering media content on a PPV basis in accordance with another embodiment of the invention is shown. The system 200 comprises content providers 1 through n in similar fashion as the system 100 shown in FIG. 1. These content providers are coupled with a content distribution network through the Internet 202. In this particular embodiment, the media content is provided in an IP format. The system 200 further comprises a network interface device 204. The network interface device 204 may comprise, for example, a data-over-cable-modem or a digital-subscriber line modem, along with a hub/router device. Of course, the use of other network interface devices is possible, such as a satellite connection to the Internet, for example.

The network interface device 204 is coupled with a media server 206 and a media client 208 via a network 210, which may be similar in configuration to the components described with respect to FIG. 1. A media content storage device 212 is also coupled with the media server 206 in a similar manner as has been previously described. For the system 200, information from the content providers 1 through n and a content distribution service 214 that is also coupled with the Internet is provided to the media server 206 via the Internet, the network interface device 204 and the network 210. The media server 206 likewise communicates with the media client via the network 210. For the system 200, the network interface device 204, the media server 206 and the media client 208 communicate using a packet based (IP) protocol.

For the system 200, the network interface device 204 receives information about the media content from the Internet. The media content may be received by the system 200 via the Internet, or by another means, such as CATV or DSS, for example. The information about the media content received from the Internet using the system 200 comprises electronic program guide (EPG) information. The EPG information is communicated to at least the media server 206, and may also be communicated (via the network 210) to the media client 208. The EPG information is employed by the media server 206 (and the media client 208) to determine the composition of the media content that is stored on the media server 206 (or the content storage device 212) so that content available for rendering on a PPV basis may be included in a media content guide (not shown). The media content guide may be rendered on a display device 214 coupled with the media server or using the display device 214 coupled with the media client 208.

It will be appreciated that numerous methods of implementing an operative connection between the network interface device 204, the media server 206 and the media client exist. For example, the operative connection may comprise a wireless connection in accordance with the IEEE 802.11 standard. Alternatively, the connection may comprise a Firewire connection in accordance with the IEEE 1394 standard. The media server 206 and media clients 208 may also be connected by daisy-chaining and accessed using a pass-through device.

Of course, numerous other techniques for implementing such a connection exist and the invention is not limited to any particular approach.

While certain features of the invention have been illustrated and described herein, many modifications, substitutions, changes and equivalents will now occur to those skilled in the art. It is, therefore, to be understood that the appended claims are intended to cover all such modifications and changes as fall within the true spirit of the invention.

What is claimed is:

1. A system for rendering media content comprising:
a first platform for storing media content, wherein the media content comprises an unrenderable state when received by the first platform;
a second platform communicatively coupled with the first platform for rendering the stored media content;
the first and second platforms cooperatively providing an interface for purchasing a right to render the stored media content at least one time; and
at least one of the first platform and the second platform being operable to convert the stored media content to a renderable state upon the purchase of the right to render.

2. The system of claim 1 further comprising:
a distribution server connected to at least one of the first and second platforms and to at least one content source, the distribution server being operable to receive requests for content and to responsively retrieve content from the content sources.

3. The system of claim 1 further comprising:
a distribution server connected to at least one of the first and second platforms and to at least one content source, the distribution server being operable to track the usage of the content.

4. The system of claim 1 further comprising:
a distribution server connected to at least one of the first and second platforms and to at least one content source, the distribution server being operable to track the payment of the content.

5. The system of claim 1 further comprising:
a distribution server connected to at least one of the first and second platforms and to at least one content source, the distribution server being operable to track the commerce of the content.

6. The system of claim 1, wherein the first platform comprises a digital video recorder device that includes a storage device for storing the media content.

7. The system of claim 6, wherein the storage device comprises a hard disk drive.

8. The system of claim 1, wherein the first platform comprises a personal computer that includes a storage device for storing the media content.

9. The system of claim 8, wherein the storage device comprises an optical storage device.

10. The system of claim 9, wherein the optical storage device comprises a digital versatile disk (DVD) drive.

11. The system of claim 1, wherein the unrenderable state comprises a first level of encryption that protects the media content from unauthorized rendering.

12. The system of claim 11, wherein the media content is contained in a broadcast signal and the unrenderable state comprises a second level of encryption that protects the media content from unauthorized reception and storage.

13. The system of claim 12, wherein the broadcast is one of an over-the-air broadcast, a cable broadcast, an Internet broadcast and a satellite broadcast.

14. The system of claim 1, wherein the first platform comprises a dedicated media storage and serving device comprising:
a storage device for retaining the media content;
a registry including one or more parameters corresponding with functional attributes of the second platform;
a network interface communicatively coupled to at least one of a media content source and to the second platform; and
a media content manager that provides for the purchase of the right to render the media content, management of rendering of the media content including enforcing digital rights associated with the media content, and controlling rendering of the media content in accordance with terms of the purchase.

15. The system of claim 14 wherein the first platform comprises:
a decryptor for decrypting the media content prior to, at least one of rendering the media content with the first platform, and communication of the media content to the second platform; and
a transcoder for translating the media from a first format to a second format, the first platform being further operable to render content from the second format.

16. The system of claim 15 wherein the first platform comprises:
a discovery service operable to search for content and to download content based on a content profile.

17. The system of claim 1, wherein the first platform comprises an encryptor that encrypts the media content prior to communication of the media content to the second platform and the second platform comprises a corresponding decryptor that decrypts the encryption of the media content performed by the first platform prior to rendering the media content.

18. The system of claim 1, wherein the second platform comprises:
a media rendering device;
a local discovery service that communicates with the first platform to determine composition of the media content;
a media communication interface for communicating with the first platform;
a guide renderer for displaying a list of titles corresponding with portions of the media content that the media rendering device can render; and
a decoder that converts the media content from an encoded format to a format that corresponds with the media rendering device.

19. The system of claim 1, wherein the media content is received via one or more of the Internet, an over-the-air transmission, a cable television transmission, a digital satellite system transmission, and an optical storage media.

20. The system of claim 1, wherein the second platform comprises a multiple format digital versatile disk player.

21. The system of claim 1, wherein the second platform comprises a personal audio player.

22. The system of claim 1, wherein the second platform comprises a high-definition television.

23. The system of claim 1, wherein the second platform comprises a digital audio receiver.

24. The system of claim 1, wherein the second platform comprises a digital video recorder.

25. The system of claim 1, wherein the second platform comprises an audio/video device comprising a decoder for converting the media content from an encoded format to a decoded, renderable format.

26. The system of claim 1, further comprising a router/network hub that operatively connects the first platform and the second platform.

27. The system of claim 26, wherein the router/network hub receives information from the Internet comprising an electronic program guide, wherein the information from the Internet is communicated to at least one of the first platform and the second platform.

28. The system of claim 27, wherein the information from the Internet is received over one of a digital subscriber line, a data-over-cable system, a dial-up connection and a satellite connection.

29. The system of claim 26, wherein the operative connection comprises a packet-based data network.

30. The system of claim 26, wherein the operative connection comprises a wireless connection.

31. The system of claim 30, wherein the wireless connection comprises a wireless connection in accordance with the IEEE 802.11 standard.

32. The system of claim 26, wherein the operative connection comprises a firewire connection in accordance with the IEEE 1394 standard.

33. The system of claim 1, further comprising a rendering controller that provides for modifying the manner in which the media content is rendered, wherein the rendering controller is implemented with at least one of the first platform and the second platform.

34. The system of claim 33, wherein the rendering controller provides for:
stopping rendering of the media content;
pausing rendering of the media content;
returning to a previously rendered point of the media content and resumption of rendering from the previously rendered point;
resuming rendering of the media content after stopping or pausing; and
skipping portions of the media content and resuming rendering of the media content from a point that occurs later in the media content.

35. The system of claim 34, wherein resuming rendering of the media content comprises resuming rendering using the second platform when rendering of the media content was paused or stopped on the first platform.

36. The system of claim 1, wherein the media content comprises:
audio content; and
combined audio/video content.

37. The system of claim 1, wherein the media content is stored on the first platform in a compressed format.

38. The system of claim 37, wherein the compressed format comprises a format in accordance with one of the MPEG-1 standard, the MPEG-2 standard and the MPEG-4 standard.

39. The system of claim 38, wherein the compressed format comprises a compressed audio format in accordance with layer 3 of the MPEG-1 standard.

40. The system of claim 1, wherein the first platform comprises:
a digital video recorder having a storage device for retaining, at least a portion, of the media content;
a personal computer operatively coupled with the digital video recorder,
wherein the personal computer provides for:
the purchase of the right to render the media content;
management of rendering of the media content including:
enforcing digital rights associated with the media content; and
controlling rendering of the media content in correspondence with terms of the purchase.

41. A system for rendering media content on a pay-per-play basis comprising:
a first platform having at least one input device for receiving media content for purchase from a content source, wherein the received content comprises encrypted and encoded information;
a storage device operatively coupled with the first platform, wherein the storage device retains the received content;
a second platform operatively coupled with the first platform and the storage device, wherein the second platform comprises an interface for purchasing the right to render the received content; and
wherein the first platform communicates the received content to the second platform, and the second platform renders the received content when purchased.

42. The system of claim 41, wherein the input device of the first platform comprises a cable receiver.

43. The system of claim 41, wherein the input device of the first platform comprises a digital satellite receiver.

44. The system of claim 41, wherein the input device of the first platform comprises an over-the-air television receiver.

46. The system of claim 41, wherein the input device comprises a router/hub coupled with the Internet.

47. The system of claim 41, wherein the first platform comprises a digital video recorder.

48. The system of claim 41, wherein the first platform comprises a personal computer.

49. The system of claim 41, wherein the received content comprises a first layer of encryption to protect the received content from unauthorized rendering and a second layer of encryption to prevent unauthorized reception and retention of the received content.

50. The system of claim 41, wherein the received content is encoded in a compressed format.

51. The system of claim 50, wherein the compressed format comprises a format in accordance with one of the MPEG-1 standard, the MPEG-2 standard and the MPEG-4 standard.

52. The system of claim 51, wherein the compressed format comprises a compressed audio format in accordance with layer 3 of the MPEG-1 standard.

53. The system of claim 41, wherein the storage device comprises a hard disk drive.

54. The system of claim 41, wherein the storage device comprises an optical storage device.

55. The system of claim 54, wherein the optical storage device comprises a digital versatile disk drive.

56. The system of claim 41, wherein the second platform implements the interface for purchasing the right to render the received content in cooperation with the first platform.

57. The system of claim 41, wherein the first platform comprises:
a decryptor that decrypts the media content;
a decoder that decodes the media content; and
a transcoder that converts the media content from a first format that is not renderable by the second platform to a second format that is renderable by the second platform and communicates the media content to the second platform.

58. The system of claim 57, wherein the first platform further comprises an encryptor for encrypting the media content prior to communicating the media content to the second platform; and wherein the second platform further comprises a decryptor for decrypting the media content as encrypted by the first platform.

59. The system of claim 41, wherein the second platform comprises:
an audio/video device including a decoder for converting the media content from an encoded format to a decoded, renderable format.

60. A system for rendering media content comprising:
a media server comprising:
a device for receiving unrenderable media content from one or more content sources;
a storage device for retaining the media content;
a content management sub-system that provides for purchase of the right to render the media content at least one time by converting the content to a renderable format, management of the rendering of the media content including enforcing digital rights associated with the media content, and controlling rendering of the media content in correspondence with terms of the purchase; and
a client device that is operatively coupled with, and discoverable by, the media server, wherein the client device comprises:
a rendering device;
a decoder for translating the media content from a first format to a second format, wherein the media content is communicated to the rendering device in the second format for playback;
a discovery sub-system that determines a subset of content playable by the rendering device within the unrenderable content contained on the media server; and
a content guide display that lists the subset of content;
wherein the media server and the client device cooperatively implement an interface to allow purchase of protected content and rendering of previously purchased content in correspondence with terms of a previous purchase using at least one of the media server and the client device.

61. A media server comprising:
a dedicated media storage and serving device for retaining a plurality of units of media content;
a client platform manager including one or more parameters corresponding with functional attributes of at least one client platform;
a media communication interface communicatively coupled to at least one media content source and to the client platform; and
a media content manager that provides for the purchase of the right to render the media content.

62. The media server of claim 61 further comprising:
an asset manager to manage the rendering of the media content including enforcing digital rights associated with the media content, and controlling rendering of the media content in accordance with terms of the purchase.

63. The media server of claim 61 further comprising:
a discovery service operable to perform network searches for content in accordance with at least one user preference.

64. The media server of claim 63 wherein the discovery service operates in accordance with a content pay service provider protocol to communicate user preferences with a content pay service provider wherein the discovery service requests content in accordance with the user preference.

65. The media server of claim 61 further comprising a content directory containing a user interface operable to display content stored in the dedicated media storage.

66. The media server of claim 65 wherein the content directory further comprises a purchase mechanism operable to input a user media selection for purchase, to communicate a purchase transaction with a content pay service provider connected to the data network, and to enable rendering of the selected media.

67. The media server of claim 66 further comprising a decrypter operable to decrypt the selected media upon completion of the purchase transaction.

68. The media server of claim 61 further comprising a decrypter operable to decrypt content received from the at least one client platform.

69. The media server of claim 61 further comprising a media rendering function operable to render media selected for rendering on a rendering device.

70. A media client comprising:
a media rendering device interface operable to communicate send renderable media to a media rendering device;
a local discovery service that communicates with a media server to determine availability of media content that may be purchased by a user and made renderable upon completion of a purchase transaction;
a media communication interface for communicating with the media server; and
a decoder that converts the media content from an encoded format to a format that corresponds with the media rendering device.

71. The media client of claim 70 further comprising:
a content directory for displaying a list of titles corresponding with units of the media content that the user may purchase and thereby send to the media rendering device to render.

73. The media client of claim 70 further comprising:
a client manager operable to generate a user interface that displays at least one title available for purchase and a query to perform a purchase transaction, the client manager further being operable to convert the unrenderable media to a renderable format.

74. The media client of claim 73 further comprising a decryptor operable to decrypt encrypted media content upon completion of the purchase transaction, the decryption producing a renderable format.

75. The media client of claim 70 further comprising a decoder/decompressor operable to convert the media in the renderable format to a media signal compatible with the rendering device.

76. A method for rendering media content on a pay-per-play basis comprising:
receiving media content with a first device, wherein the media content comprises at least one level of content unrenderability;
storing the media content locally;
displaying a content guide comprising a listing describing the unrenderable media content;
receiving a request to purchase a rendering right for the protected media content, the request being generated from the content guide;
removing a first level of content unrenderability;
rendering the media content at least one time, wherein at least a part of the media content is rendered on a second device.

77. The method of claim 76, further comprising removing a second level of content unrenderability after receiving the media content and prior to storing the media content.

78. The method of claim 76, further comprising decoding and decompressing the media content prior to rendering the media content.

79. The method of claim 76, further comprising transcoding the media content from a first format to a second format prior to rendering the content, such that the transcoded media content is renderable by a selected rendering device.

80. The method of claim 76, wherein removing the first level of content unrenderability comprises decrypting the media content.

81. The method of claim 76, wherein removing the first level of content unrenderability comprises unlocking a data file including the media content.

82. The method of claim 76, wherein rendering the media content on the second device comprises providing a media content stream from the first device to the second device.

83. The method of claim 76, further comprising, prior to rendering the media content:
removing the first level of content unrenderability with the first device;
encrypting the media content with the first device;
communicating the media content from the first device to the second device as an encrypted media stream; and
decrypting the encrypted media stream with the second device.
